(19) United States
(12) Patent Application Publication
(10) Pub. No.: US 2014/0142890 A1
(43) Pub. Date: May 22, 2014

(54) METHODS AND SYSTEMS FOR DETERMINING PORE SIZE IN SEDIMENT

(71) Applicants: Hugh Callahan Daigle, Houston, TX (US); John Thomas Balczewski, Houston, TX (US)

(72) Inventors: Hugh Callahan Daigle, Houston, TX (US); John Thomas Balczewski, Houston, TX (US)

(73) Assignee: Chevron U.S.A. Inc., San Ramon, CA (US)

(21) Appl. No.: 14/081,838

(22) Filed: Nov. 15, 2013

Related U.S. Application Data
(60) Provisional application No. 61/727,567, filed on Nov. 16, 2012.
(60) Provisional application No. 61/727,569, filed on Nov. 16, 2012.

(51) Int. Cl. G01N 15/02

(52) U.S. Cl. CPC G01N 15/0227
USPC 702/157

(57) ABSTRACT

Methods and systems for determining a maximum pore size in a distribution of varying-sized spherical particles are disclosed. One method includes distributing a plurality of particles within a volume, and, at each point unoccupied by a particle, inscribing a sphere and determining a size of the sphere. The method further includes determining a maximum size of a sphere from among the spheres inscribed at each unoccupied point, thereby locating a maximum pore size location within the volume.

### CROSS-REFERENCE TO RELATED APPLICATIONS

The present application claims priority from U.S. Provisional Patent Application No. 61/727,567, filed on Nov. 16, 2012, and U.S. Provisional Patent Application No. 61/727,569, filed on Nov. 16, 2012, the disclosures of each of which are hereby incorporated by reference in their entireties.

### TECHNICAL FIELD

The present application relates generally to determining a pore size in a medium having varying size grains. In particular, the present application relates to determining a pore size in sediment using physical measurement or modeling of sediment samples.

### BACKGROUND

“Clathrates” generally refer to non-stoichiometric metastable substances in which lattice structures composed of first molecular components (host molecules) trap or encage one or more other molecular components (guest molecules) in what resembles a crystal-like structure. Clathrates are sometimes referred to as inclusion compounds, hydrates, gas hydrates, methane hydrates, natural gas hydrates, CO2 hydrates and the like.

In the field of hydrocarbon exploration and development, clathrates are of particular interest. For example, clathrates exist in which water host molecule lattices encage one or more types of hydrocarbon guest molecule(s). Such hydrocarbon clathrates occur naturally in environments of relatively low temperature and high pressure where water and hydrocarbon molecules are present, such as in deepwater and permafrost sediments. Clathrates at lower temperatures remain stable at lower pressures, and conversely clathrates at higher temperatures require higher pressures to remain stable.

It has been shown theoretically and experimentally that clathrates form preferentially in sediments with larger pores. For regular packings of uniformly sized spheres, the pore size may be determined analytically by considering the system geometry. The resulting correlations among particle size, porosity, and pore size are capable of being derived, but are of limited applicability to natural sediments, since natural sediments typically contain grains with a distribution of sizes. Other existing models solve this problem by considering size of inscribed spheres within tetrahedra with vertices defined by the centers of four neighboring grains. While computationally simple, this method may not capture the true pore system complexity in natural materials.

As such, improvements in methods and systems for detecting porosity of sediment samples would be desirable, in particular for assisting in determining whether conditions exist for formation of clathrates.

### SUMMARY

In accordance with the following disclosure, the above and other issues are addressed by the following:

In a first aspect, a method for determining a maximum pore size in a distribution of varying-sized spherical particles is disclosed. The method includes distributing a plurality of particles within a volume, and, at each point unoccupied by a particle, inscribing a sphere and determining a size of the sphere. The method further includes determining a maximum size of a sphere from among the spheres inscribed at each unoccupied point, thereby locating a maximum pore size location within the volume.

In a second aspect, a computer-readable storage medium is disclosed that includes computer-executable instructions which, when executed, cause a computing system to perform a method of detecting a maximum pore size in a distribution of varying-sized spherical particles. The method includes distributing a plurality of particles within a volume, and, at each point unoccupied by a particle, inscribing a sphere and determining a size of the sphere. The method further includes determining a maximum size of a sphere from among the spheres inscribed at each unoccupied point, thereby locating a maximum pore size location within the volume.

In a third aspect, a computing system is disclosed that includes a clathrate saturation probability application configured to execute on the computing system, the clathrate saturation probability application including a modeling component configured to distribute modeled particles within a model volume. The computing system further includes a pore size analysis component configured to inscribe a sphere and determine a size of the sphere at each point unoccupied by a modeled particle, and to determine a maximum size of a sphere from among the spheres inscribed at each unoccupied point, thereby locating a maximum pore size location within the volume.

### BRIEF DESCRIPTION OF THE DRAWINGS

FIG. 1 is a schematic illustration of an offshore hydrocarbon production system including a production facility which receives and processes hydrocarbons from one or more clathrate reservoirs;

FIG. 2 is a schematic illustration of an onshore hydrocarbon production system including a production facility which receives and processes hydrocarbons from one or more clathrate reservoirs;

FIG. 3 is a schematic illustration of a computing system in which a probability of the presence of clathrates of a predetermined concentration can be calculated;

FIG. 4 is a flowchart illustrating an example method for determining a maximum pore size in a distribution of varying-sized spherical particles, according to an example embodiment of the present disclosure;

FIG. 5 is a flowchart illustrating a second method for determining a maximum pore size in a distribution of varying-sized spherical particles, according to an example embodiment of the present disclosure;

FIG. 6 is a schematic view of a volume including spherical particles having a distribution based on observed physical characteristics of a sediment sample, according to an example embodiment;

FIG. 7 is a schematic view of the volume of FIG. 6, illustrating a method of calculating a maximum pore size in the volume according to an example embodiment;

FIG. 8 is a flowchart illustrating an example method for determining a maximum pore size in a distribution of varying-sized spherical particles, according to an example embodiment of the present disclosure;

FIG. 9 is a flowchart illustrating a method for determining a maximum pore size in a distribution of varying-sized spherical particles, as well as a corresponding clathrate saturation, according to an example embodiment of the present disclosure;

FIG. 10 is a schematic view of a volume including point vertices positioned within the volume by random or user-selected processes, and representing central points for spherical particles representing sediment grains, according to an example embodiment;

FIG. 11A is a schematic view of a volume including spherical particles representing sediment grains, and having a distribution of grains grown from the point vertices until in point contact with a neighboring grain, according to an example embodiment;

FIG. 11B is a schematic view of a volume including spherical particles representing sediment grains, and having a distribution of grains grown from the point vertices until a predetermined distance from a neighboring grain, according to an example embodiment;

FIG. 12A is a schematic view of the volume of FIG. 11A, illustrating a method of calculating a maximum pore size in the volume according to an example embodiment;

FIG. 12B is a schematic view of the volume of FIG. 11B, illustrating a method of calculating a maximum pore size in the volume according to an example embodiment; and

FIG. 13 is a graph of porosities based on the median grain diameter of a particular arrangement of varying-size sediment grains, according to an example embodiment.

### DETAILED DESCRIPTION

As briefly described above, embodiments of the present invention are directed to methods and systems for determining maximum pore size in a sediment sample having variable grain size. In particular, some embodiments discussed herein use physical observation of sediment sample characteristics, such as via image capture and analysis or via some other type of analysis of a distribution of particle sizes. This information can be used, in turn, to determine a probability of the existence of clathrates of a sufficient saturation. In such embodiments, imaging techniques like X-ray computed tomography can be used to create digital images of natural sediment samples. These digital images may then be used to determine distributions of grain and pore sizes without having to make assumptions regarding pore or grain shape. In alternative embodiments, numerical analysis can be performed using three-dimensional models of sediment and clathrate formations having varied particle sizes and concentrations, respectively.

For the purposes of this disclosure, the term “clathrate” will include any and all types of lattice (host) molecule(s) and any and all types of encaged (guest) molecule(s) in all possible combinations. Clathrates can include, for example, transitions between various clathrate lattice structure types; formation, stable state and dissociation, and the substitution of one or more type(s) of molecule by one or more other type(s) of molecule.

I. Clathrate Harvesting and Modeling Structures

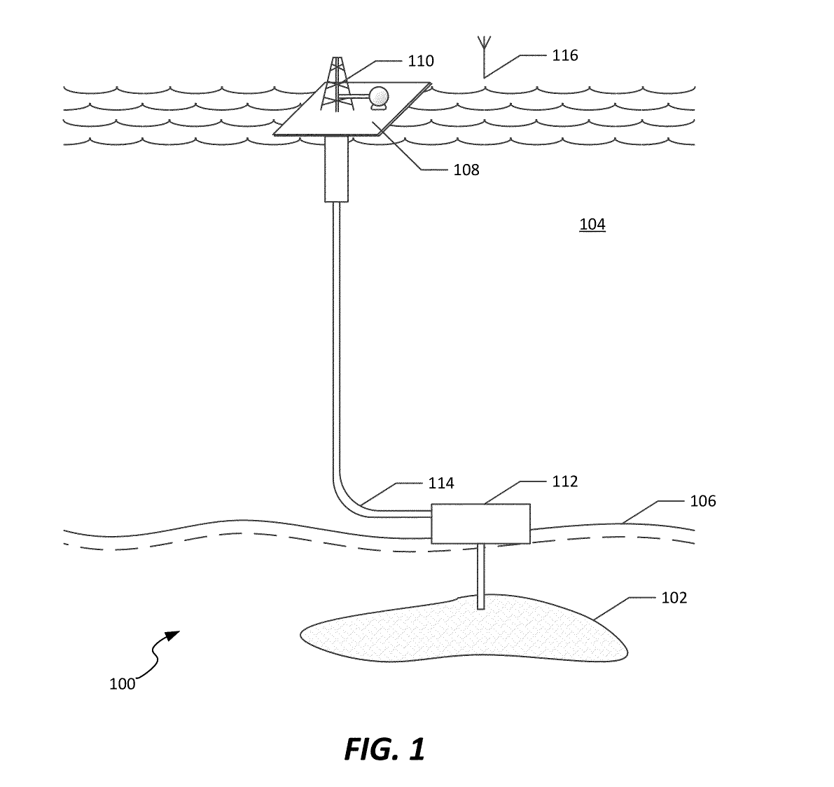

FIG. 1 is a schematic drawing of an example embodiment of an offshore or deepwater hydrocarbon production system 100. System 100 includes a clathrate reservoir 102 disposed beneath sea water 104 and seafloor 106. This clathrate reservoir 102 produces water and hydrocarbons, primarily natural gas. In the embodiment shown, an offshore platform 108 supports a production facility 110, which is used to at least partially separate liquids, water and/or oil, from natural gas.

In this example embodiment, the clathrate reservoir 102 is shown in fluid communication with a subsea well 112 which, in turn, is connected to production facility 110 by way of tieback 114. Clathrate reservoir 102 primarily produces a mixture of natural gas and water which is delivered to production facility 110 for separation of natural gas and water, and oil if there are significant amounts of oil contained within the mixture.

It is noted that, in the embodiment shown in FIG. 1, a wave generation and detection system 116 can be used prior to installation of the overall hydrocarbon production system 100, and can be used to locate the system 100 at a particular location along the seafloor 106. The wave generation and detection system 116 can be, for example a seismic or other acoustic wave generation system, or other system capable of generating waves that are able to penetrate the sea water 104 and seafloor 106, and to capture reflected waves, and thereby detect differences in the media through which the waves travel based on speed of travel.

It is noted that the production system 100 shown in FIG. 1 is only an exemplary embodiment. Those skilled in the art will appreciate that it is within the scope of the present invention to provide a hydrocarbon production system that combines multiple such clathrate reservoirs and associated wells, or combination of such a clathrate reservoir and associated well with conventional hydrocarbon reservoir and well systems. An example of such a system is illustrated in U.S. Pat. No. 8,232,428, filed Aug. 25, 2008, the disclosure of which is hereby incorporated by reference in its entirety.

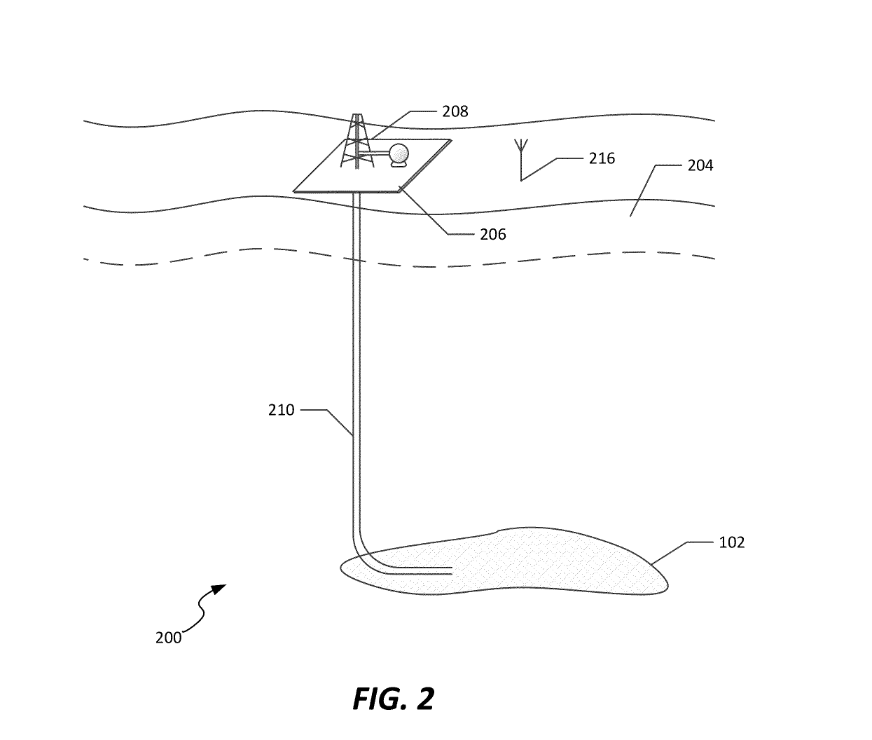

FIG. 2 is a schematic drawing of another exemplary embodiment of a hydrocarbon production system 200 which, in this case, is located on land rather than being based offshore. Production system 200 includes a clathrate reservoir 202. Disposed upon a permafrost layer 204 is an arctic platform 206. A production facility 208, generally similar to production system 110, is located atop arctic platform 206. Production facility 208 is used to separate and process natural gas, oil and water received from the clathrate reservoir 202. Production tubing 210 is used to fluidly convey a mixture of clathrates and water from clathrate reservoir 202 to arctic platform 206 and production facility 208. The mixture may include, in some cases, a small portion of oil.

As with the hydrocarbon production system 100 of FIG. 1, it is noted that in the context of the on-land arrangement of FIG. 2, a wave generation and detection system 216, analogous to system 116 of FIG. 1, can be used prior to installation of the overall hydrocarbon production system 200, and can be used to locate the system 200 at a particular location. The wave generation and detection system 216 can include any of a variety of types of seismic, acoustic, or other system capable of generating waves that are able to penetrate the permafrost layer 204, and to capture reflected waves, and thereby detect differences in the media through which the waves travel based on speed of travel. It is noted that, in the example of FIG. 2, there are likely to be greater variations in densities at shallower depths, based on the comparative uniformity of sea water as compared to variations found in the on-land subsurface sediments. In either case, such data can be captured for use in some embodiments of the present disclosure, as discussed in further depth below.

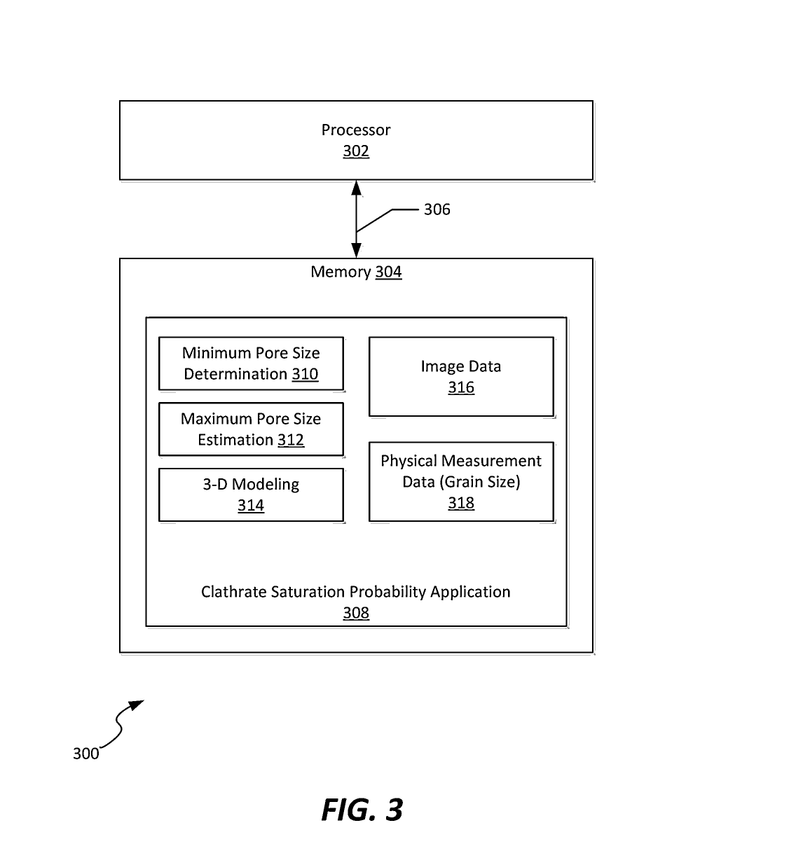

Referring now to FIG. 3, an example computing system 300 is illustrated that can be used to calculate whether conditions exist for presence of clathrates, such as can be used to locate a production system such as those shown in FIGS. 1-2. In general, the computing system 300 includes a processor 302 communicatively connected to a memory 304 via a data bus 306. The processor 302 can be any of a variety of types of programmable circuits capable of executing computer-readable instructions to perform various tasks, such as mathematical and communication tasks.

The memory 304 can include any of a variety of memory devices, such as using various types of computer-readable or computer storage media. A computer storage medium or computer-readable medium may be any medium that can contain or store the program for use by or in connection with the instruction execution system, apparatus, or device. In the embodiment shown, the memory 304 stores a clathrate saturation probability analysis application 308. The clathrate saturation probability analysis application 308, when executed, can be used to calculate or determine whether conditions exist for the presence of clathrates of a predetermined concentration. For example, the application 308 can calculate a thickness of a clathrate stability zone, i.e., a range of depths at which pressures and temperatures are such that clathrate formation is possible. The application 308 can also compute an in situ temperature and a three-phase equilibrium temperature for clathrate phases within the calculated clathrate stability zone.

In some embodiments, the application 308 includes a number of components computer-executable code including a minimum pore size determination component 310, a maximum pore size analysis component 312, and optionally a three-dimensional modeling component 314. The minimum pore size determination component 310 is configured to determine a minimum pore size supporting a predetermined clathrate saturation based at least in part on the in situ temperature and the three-phase equilibrium temperature. The predetermined clathrate saturation can be, for example, a desirable clathrate saturation selectable by a user. In some embodiments, the minimum pore size determination component 310 also calculates the thickness of the clathrate stability zone and three-phase and in situ temperatures, in place of the application 308 overall. In such cases, the thickness of the stability zone may be based on the particular type of clathrate (e.g., methane hydrates, etc.) to be detected, and can be based at least in part on observed temperatures and pressures across a range of subsurface depths (e.g., from a different test well or other historical knowledge of an area). The minimum pore size determination component 310 is also configured to calculate a minimum pore radius in which clathrates of the given concentration can be formed. This calculation can be, for example based on the Gibbs-Thompson effect. Details regarding this computation are discussed in further detail in U.S. Provisional Patent Application No. 61/727,560 filed on Nov. 16, 2012, and entitled “Methods and Systems for Determining Minimum Porosity for Presence of Clathrates in Sediment Using Empirical Relationships” (Docket No. T-9172), the disclosure of which is hereby incorporated by reference in its entirety.

The maximum pore size analysis component 312 is configured to determine a maximum pore size that is to be expected in a clathrate stability zone. In other words, the component 312 is configured to, for example, determine a maximum pore sized based on modeling of sediment grains of varying size positioned within a volume, and analyze a pore size within that volume. The maximum pore size analysis component 312 can use a grain size analysis component, such as the physical measurement module 318 or image analysis module 316, discussed below, to determine a distribution of grain sizes in a sediment sample under review.

In addition, the application 308 can include a comparison component or otherwise be configured to compare the empirically determined maximum pore size with the minimum pore size supporting the predetermined clathrate saturation to determine whether the predetermined clathrate saturation is possible in the clathrate stability zone. Based on such a comparison of the output of components 310, 312, it can be determined whether such a concentration of clathrates is possible, and therefore whether direct underground exploration is worth pursuing.

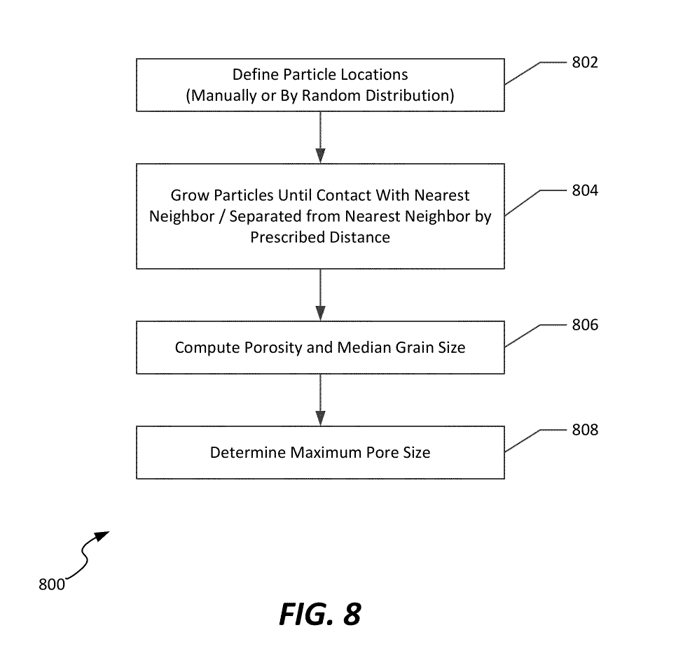

In some embodiments, the application 308 can include a three-dimensional data modeling component 314. The three-dimensional data modeling component 314 can be configured to model, in a particular volume, a distribution of grains of varying sizes, and can be used by the maximum pore size analysis component 312 to determine a maximum pore size based on the model built in the three-dimensional data model. Further details regarding example modeling that can be performed are provided below in connection with FIGS. 8-13.

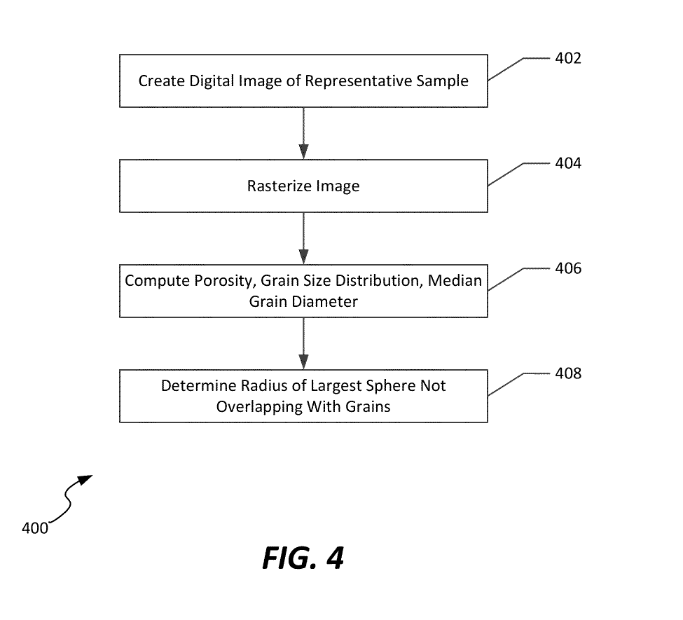

Optionally, in some embodiments the memory 304 can also include one or more additional components that allow for determining a maximum pore size available in sediment, such as an empirical data analysis module 316 and a physical measurement data module 318. The empirical data analysis module 316 can contain one or more models of sediment properties, and can include or receive data regarding a particular type or sample of sediment. For example, the empirical data analysis module 316 can be used alongside the maximum pore size estimation component 312 to determine a maximum porosity based on, for example, historical data, or sample data, or other types of empirical data. Additional details regarding such physical measurements and use in clathrate estimation are discussed in further detail below in connection with FIGS. 4-7.

The physical measurement data module 318 is capable of receiving physical measurements of subsurface sediments and performing any of a variety of physical measurement processes, as are described herein. This can include any of a variety of direct physical measurements, such as laser particle size analysis, Stokes settling analysis, image analysis, or other techniques, to determine a distribution of particle sizes in a particular sample. Additional details regarding use and operation of modules 316, 318 are provided in U.S. Provisional Patent Application No. 61/727,560 filed on Nov. 16, 2012, and entitled “Methods and Systems for Determining Minimum Porosity for Presence of Clathrates in Sediment Using Empirical Relationships” (Docket No. T-9172), which was previously incorporated by reference.

Referring to FIG. 3 overall, it is noted that other modules or features could be incorporated into such a computing system 300 overall, or into an application such as application 308. Furthermore, although it is noted that some components or modules include specified functionality, this functionality could generally also be said to reside within the application 308 overall, or could be implemented across a multi-processor system, or multi-computer network.

II. Maximum Pore Size Determinations for Clathrate Formation

Referring now to FIGS. 4-13, various embodiments of methods and systems for determining a maximum pore size are provided, for use in analyzing sediment to determine support for clathrate formation. In general, FIGS. 4-7 illustrate an example methodology for determining maximum pore size from physical measurements of particles in a sediment sample, while FIGS. 8-13 illustrate an alternative methodology for determining maximum pore size using numerical modeling. Such pore size determinations can be used, for example, in comparison to minimum pore sizes or porosities required for formation of clathrates, such as is disclosed in U.S. Provisional Patent Application No. 61/727,555, filed on Nov. 16, 2012 and entitled “Methods and Systems for Determining Minimum Porosity for Presence of Clathrates in Sediment” (Docket No. T-9033), and U.S. Patent Application No. ______, bearing the same title and filed the same day herewith, the disclosures of each of which are hereby incorporated by reference in their entireties.

Referring now to FIG. 4-7, a general methodology for determining maximum pore size from physical measurements of a sediment sample is provided. In particular, FIG. 4 illustrates a flowchart illustrating an example method 400 for determining a maximum pore size in a distribution of varying-sized spherical particles, according to an example embodiment of the present disclosure. The method 400 can be performed, for example, on a computing system such as system 300 of FIG. 3, and can be embodied within an application having a plurality of computation components based on observed physical measurements, such as the application 308 of FIG. 3.

In the embodiment shown, the method 400 is initiated by capturing an image of a sample of natural sediment of representative size (step 402). The image that is captured is typically a digital image, and is preferably a three-dimensional digital image or series of two-dimensional digital images useable to reconstruct a three-dimensional digital representation of the sediment sample. For example, such an image can be captured using X-ray computed tomography, or some analogous method.

After the digital image is captured, the digital image is then rasterized to determine or identify different areas in the image, in particular areas within the image where sediment grains occupy the space, and other areas where pores are formed in the space (step 404). This rasterized image is then used to determine porosity and median grain size (step 406). In some embodiments, porosity can be determined by using an algorithm obtained from a numerical simulation of packings of randomly sized spheres. This algorithm relates porosity to the ratio of the maximum pore radius to the median grain diameter of the packing. Details regarding one example method for providing porosity calculations are provided in copending U.S. patent application No. 61/727,555, filed on Nov. 16, 2012 and entitled “Methods and Systems for Determining Minimum Porosity For Presence of Clathrates in Sediments” (Docket No. T-9033), and U.S. patent application No. ______, bearing the same title and filed the same day herewith, the disclosures of which were previously incorporated by reference. Data associated with the median grain size and porosity can then be stored, for example, by the application 308 as physical measurement data by the physical measurement data module 318.

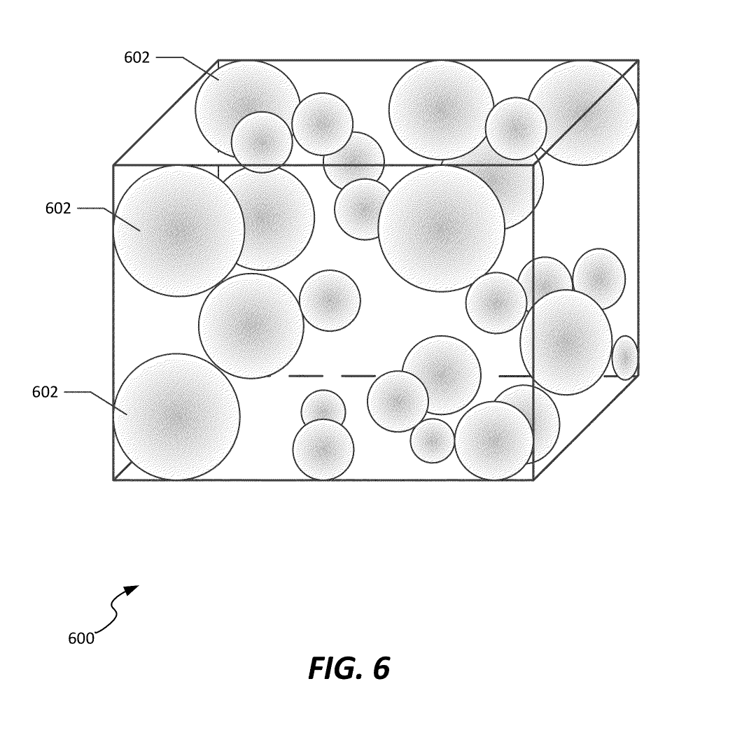

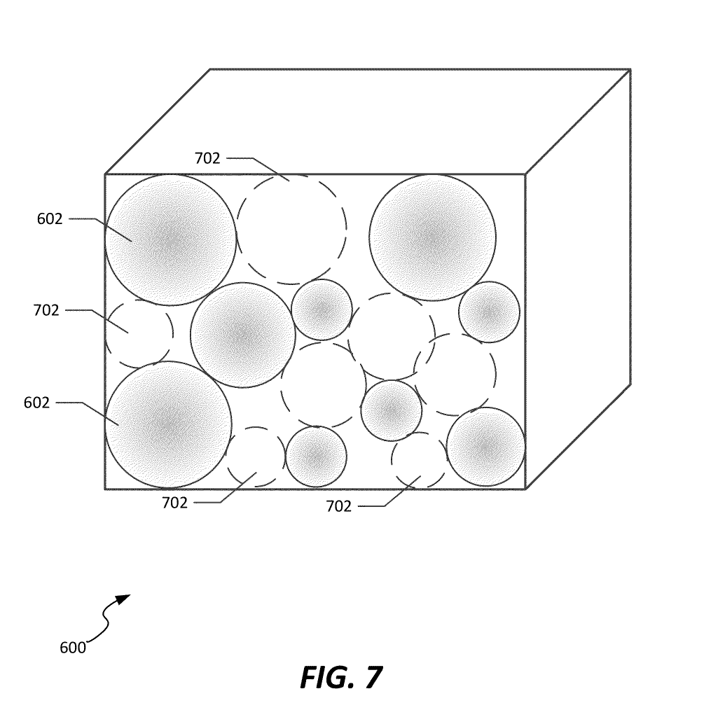

Using the median grain size and porosity, and optionally the digital image captured as an image, a three-dimensional model can be generated in the three-dimensional modeling component 314 (see, e.g., FIG. 6). In particular, and as seen in FIG. 6, a volume 600 includes grains 602 arranged as observed in the digital image. The three-dimensional modeling component 314 and associated model can then be used by the maximum pore size component 312 to determine a maximum pore size in the three-dimensional model (step 408). This can include, for example, systematically stepping through each vacant point within the three-dimensional model and, at each point not occupied by a sediment grain, the maximum radius of a sphere is determined such that the sphere is the largest sphere that may be inscribed at that point without touching a sediment grain. An example of such an arrangement is shown in FIG. 7, in which, within the volume 600, example pore size spheres 702 are illustrated to shown pore sizes that are possible for formation of clathrates. The radius of the inscribed sphere is the pore size, and a maximum pore size determined in this manner is an estimated maximum pore size expected to be observed in the sample under consideration. It is noted that in FIG. 7, the pore size spheres are depicted in two dimensions for ease of illustration; however, it is noted that the pore size determination is based on spherical pore size, and as such occurs in three dimensions within the volume 600.

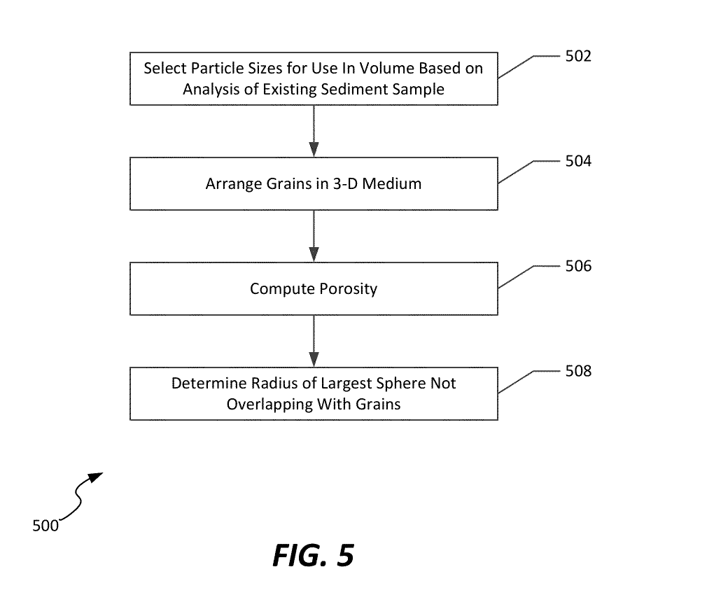

Referring now to FIG. 5, a flowchart of an alternative method for determining a maximum pore size in a distribution of varying-sized spherical particles is shown, according to an example embodiment of the present disclosure. The method 500 of FIG. 5 can also be performed, for example, on a computing system such as system 300 of FIG. 3, and can be embodied within an application having a plurality of computation components based on observed physical measurements, such as the application 308 of FIG. 3.

In the embodiment shown, the method 500 is initiated by determining a grain size distribution for a natural sediment sample under consideration (step 502). This can include, for example, performing a laser particle size analysis or Stokes settling analysis on the sediment sample. A collection of spherical particles having a distribution of sizes is selected for use in modeling, with the distribution of sizes corresponding to the sizes determined during the analysis of the physical sample, for example by using a Monte Carlo method as applied to the cumulative grain size distribution.

Once a selection of grains of various sizes is selected, the grains are arranged in a three-dimensional model volume by a three-dimensional data modeling component 314 (step 504). When the grains are located in the volume, one or more restrictions are placed on those grains. In one example, the grains are arranged such that all of the grains are in point contact with at least one neighboring grain. An example of such an arrangement is seen in FIG. 6, in which a volume 600 can be generated using the three-dimensional modeling component 314, with grains 602 of varying sizes in point contact with each other.

Referring back to FIG. 5, following arrangement of the grains, porosity of the resulting medium is computed by the application 308 (step 506). In some embodiments, porosity can be determined by using an algorithm obtained from a numerical simulation of packings of randomly sized spheres, as discussed above in connection with step 406 of FIG. 4.

Once a porosity is determined, a maximum pore size analysis component 312 will assess each point within a modeled volume, such as the volume generated by the three-dimensional modeling component 314, to determine a maximum radius of a sphere, such that the sphere is the largest sphere that may be inscribed at that point without touching a grain (step 508). The radius of this inscribed sphere is the pore size. The maximum pore size is determined by finding the maximum diameter of a sphere that may be inscribed in the pore space at each node not occupied by grain material. As mentioned above, an example of such an arrangement is shown in FIG. 7, in which, within the arrangement 600, example pore size spheres 702 are illustrated to shown pore sizes.

Referring now to FIGS. 8-13, a general methodology for determining maximum pore size from physical measurements of a sediment sample is provided. In particular, in FIG. 8, a flowchart illustrating an example method 800 for determining a maximum pore size in a distribution of varying-sized spherical particles is shown, according to an example embodiment of the present disclosure. The method 800 can be performed, for example, on a computing system such as system 300 of FIG. 3, and can be embodied within an application having a plurality of computation components based on observed physical measurements, such as the application 308 of FIG. 3.

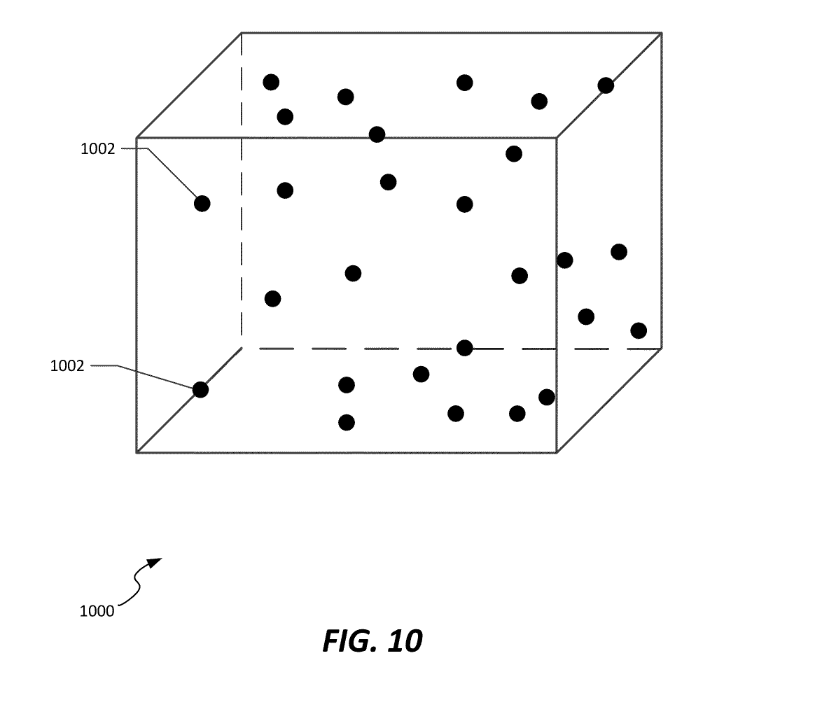

In the embodiment shown, the method 800 is initiated by defining one or more particle locations in a defined three-dimensional volume (step 802). The particle locations correspond to center vertices at which particles of varying sizes are to be located. The particle locations can be selected randomly, or manually selected by a user, and are defined in a three dimensional volume. Furthermore, in some embodiments, the size and shape of the three dimensional volume can be defined by a user, for example in the case where a particular size or shape of sediment deposit is under consideration. One example arrangement of selection of particle locations is illustrated in FIG. 10, where a generally rectangular volume 1000 includes a number of point vertices 1002 that are selected and located either manually or by random distribution.

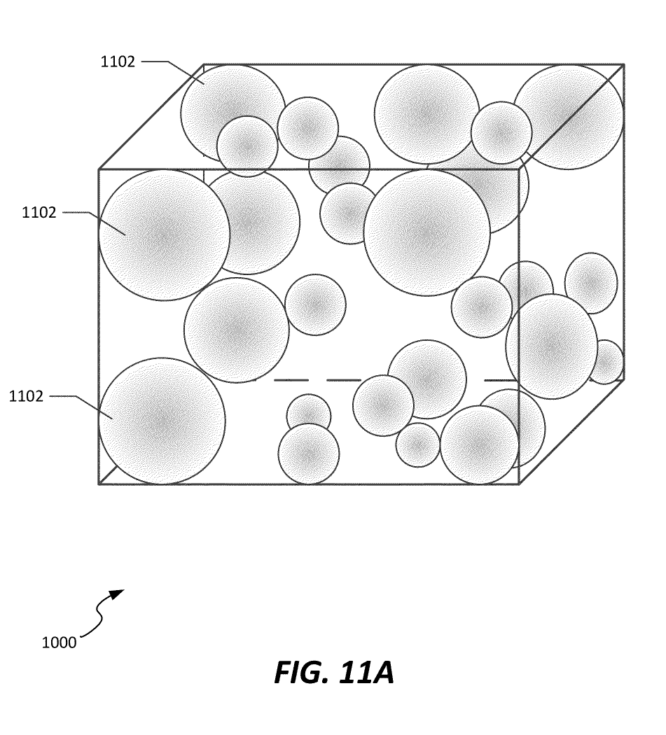

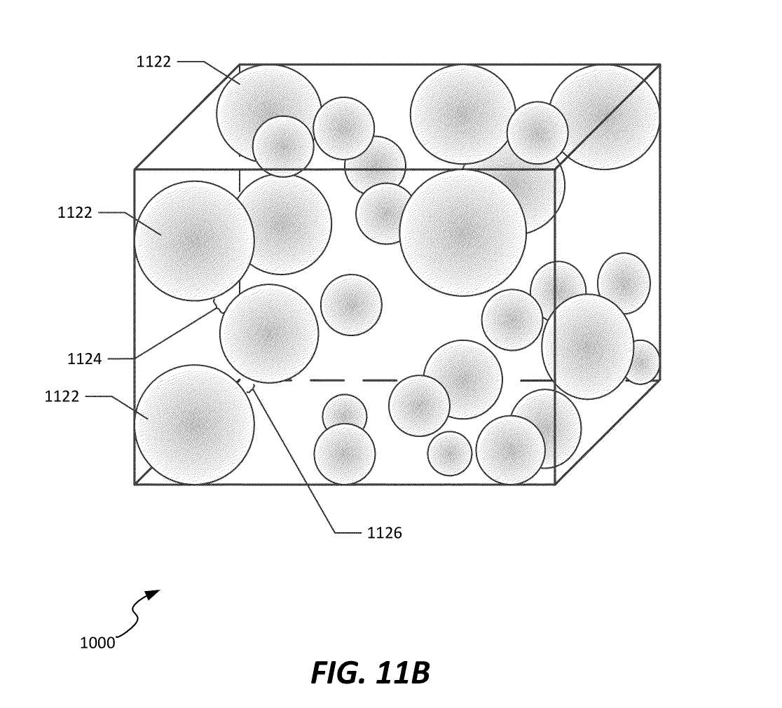

Once particle locations are selected, the particles are grown to a predetermined extent (step 804). In some embodiments, particles are grown until point contact is made with a nearest neighbor. Such an example embodiment is illustrated in FIG. 11A, which shows a model managed by three-dimensional modeling component 314 in which spherical sediment particles 1102 replacing the point vertices 1002 of FIG. 10 in the volume. In this illustration, each sediment grain is modeled to grow until intersecting with a point on a nearest neighbor particle. It is noted that, based on this simulation of particle growth until point contact with a neighboring particle, selecting the number and location of particles, or allowing a higher or lower density of particle locations, has the effect of producing either a smaller number of larger sediment particles (for fewer particles) or a larger number of smaller sediment particles (for more particles).

In an alternative embodiment, each of the particles are grown until they are a predetermined distance away from a nearest-neighbor particle. In such embodiments, it is possible to allow a user to define a common predetermined distance for all particles, or different distances between different particles. This is illustrated in the example of FIG. 11B, which illustrates a model managed by three-dimensional modeling component 314 in which spherical sediment particles 1122 replacing the point vertices 1002 of FIG. 10 in the volume. As compared to the particles 1102 of FIG. 11A, adjacent spherical sediment particles 1122 are spaced apart. In the particular embodiment shown, different distances are provided between different particles, with distances 1124 and 1126 representing example selected limits on modeled particle growth.

Referring back to FIG. 8, following arrangement of the grains, porosity of the resulting medium is computed by the application 308 (step 806). In some embodiments, porosity can be determined by using an algorithm obtained from a numerical simulation of packings of randomly sized spheres. This algorithm relates porosity to the ratio of the maximum pore radius to the median grain diameter of the packing. Details regarding one example method for providing porosity calculations are provided in U.S. Provisional Patent Application No. 61/727,555, filed on Nov. 16, 2012 and entitled “Methods and Systems for Determining Minimum Porosity for Presence of Clathrates in Sediment”, U.S. Patent Application No. ______, bearing the same title and filed the same day herewith, and U.S. Provisional Patent Application No. 61/727,560, filed on Nov. 16, 2012 and entitled “Methods and Systems for Determining Minimum Porosity for Presence of Clathrates in Sediment Using Empirical Relationships” (Docket No. T-9172), the disclosures of which are each incorporated by reference in their entireties. Data associated with the median grain size and porosity can then be stored, for example, by the application 308 as physical measurement data by the physical measurement data module 318.

A maximum pore size analysis component 312 will assess each point within a modeled volume, such as the volume generated by the three-dimensional modeling component 314, to determine a maximum radius of a sphere, such that the sphere is the largest sphere that may be inscribed at that point without touching a grain (step 808). The radius of this inscribed sphere is the pore size. The maximum pore size is determined by finding the maximum diameter of a sphere that may be inscribed in the pore space at each node not occupied by grain material.

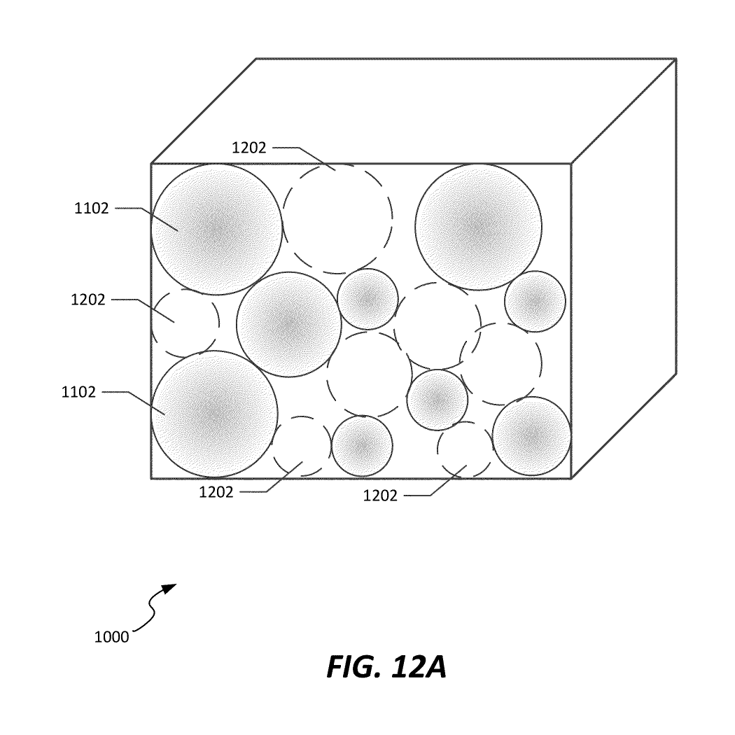

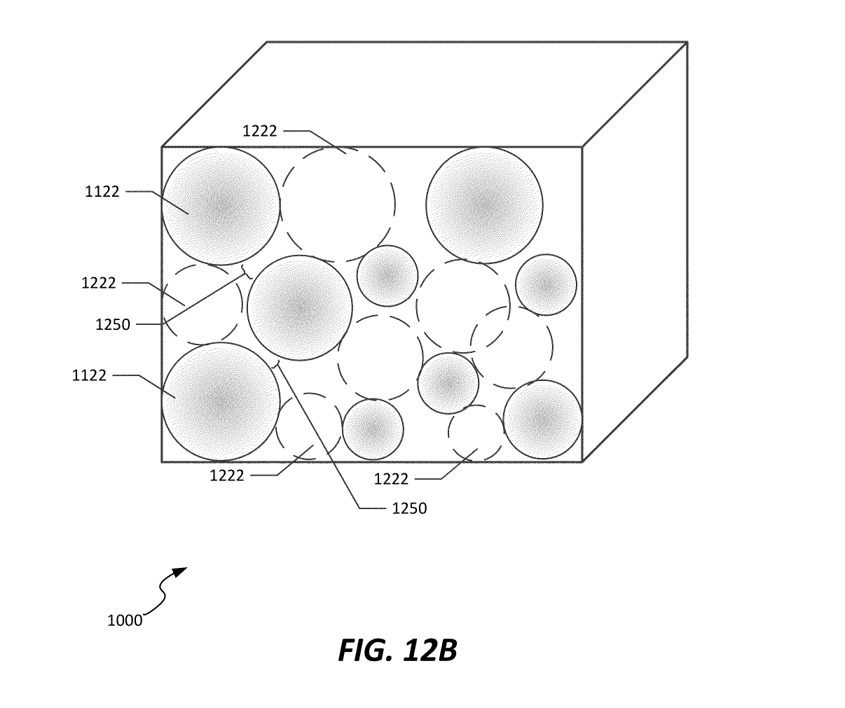

Example arrangements in which a maximum pore space is determined are illustrated in FIGS. 12A-12B. In particular, FIGS. 12A-12B illustrate that, within the volume 1000, example pore size spheres 1202, 1222 are illustrated to shown pore sizes that are possible for formation of clathrates. The radius of the inscribed sphere is the pore size, and a maximum pore size determined in this manner is an estimated maximum pore size expected to be observed in the sample under consideration. FIG. 12A illustrates modeling of pore size spheres 1202 inscribed between adjacent grains 1102 of FIG. 11A, which were in point contact with each other. FIG. 12B illustrates modeling of pore size spheres 1222 inscribed between grains spaced apart by one or more proscribed distances, e.g., distances 1124, 1126 of FIG. 11B.

It is noted that in FIGS. 12A-12B, the pore size spheres are depicted in two dimensions for ease of illustration; however, it is noted that the pore size determination is based on spherical pore size, and as such occurs in three dimensions within the volume 600.

Once a maximum pore size is determined using inscribed pore size spheres such as is illustrated in FIGS. 12A-12B, in some embodiments a concentration of clathrates that are potentially formed within the pores in sediments can be calculated based on the conditions at the sediment sample under consideration. For example, in general, a minimum possible porosity supporting a given clathrate concentration can be compared to the maximum pore size determined using the method 800 to determine whether that concentration of clathrates could theoretically be found in the sediment at the location under review. Details regarding such a calculation are described in U.S. Provisional Patent Application No. 61/727,555, filed on Nov. 16, 2012 and entitled “Methods and Systems for Determining Minimum Porosity for Presence of Clathrates in Sediment”, U.S. Patent Application No. ______, bearing the same title and filed the same day herewith, and U.S. Provisional Patent Application No. 61/727,560, filed on Nov. 16, 2012 and entitled “Methods and Systems for Determining Minimum Porosity for Presence of Clathrates in Sediment Using Empirical Relationships” (Docket No. T-9172), the disclosures of which were previously incorporated herein by reference.

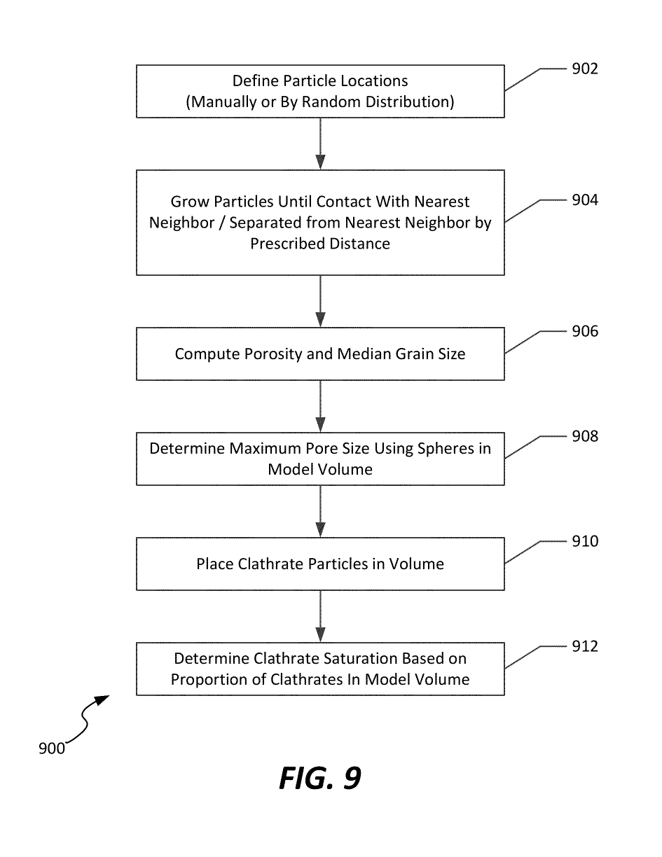

Referring now to FIG. 9, a flowchart illustrating a method 900 for determining a maximum pore size in a distribution of varying-sized spherical particles, as well as a corresponding clathrate saturation, is shown according to an example embodiment of the present disclosure. The method 900 generally can be performed, for example, on a computing system such as system 300 of FIG. 3, and can be embodied within an application having a plurality of computation components based on observed physical measurements, such as the application 308 of FIG. 3.

In general, method 900 includes steps 902-908, which are analogous to steps 802-808 described above in connection with FIG. 8. However, FIG. 9 further includes an additional, alternative methodology for determining a clathrate concentration. Specifically, method 900 includes populating the volume 1000 with clathrate particles (e.g., particles 1202, 1222, of FIGS. 12A-12B) (step 910). In this arrangement, rather than simply determining a maximum radius of a single clathrate particle in the volume 1000, in this case each pore opening is populated with a clathrate particle having a size of the maximum pore size determined in step 908. Following that, an estimated clathrate concentration can be calculated as the ratio of the volume occupied by clathrate crystals to the total volume not occupied by sediment particles (step 910).

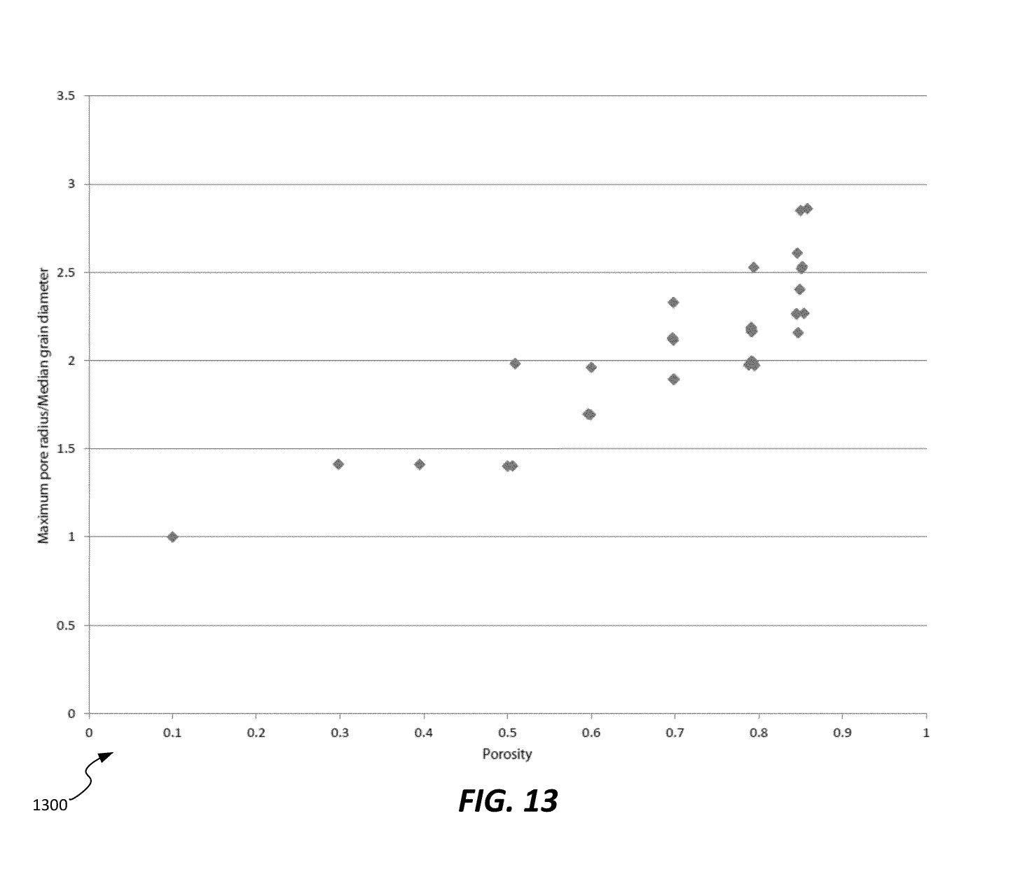

Referring now to FIG. 13, a chart 1300 is shown that illustrates example results from 35 model runs at different sediment porosities. The results show a roughly linear relationship between porosity and the ratio of maximum pore radius to median grain size.

Referring to FIGS. 1-13 overall, it is noted that an ability to determine pore size for a physically representative porous medium has a variety of applications, including determining irreducible saturation of a non-wetting phase, maximum size of authigenic crystals during diagenesis, and local solubility effects due to pore size constraints. In some applications, the pore size can be used to determine whether clathrates of a particular saturation can exist within the particular sediment sample. Example applications to that effect are discussed in U.S. Provisional Patent Application No. 61/727,555, filed on Nov. 16, 2012 and entitled “Methods and Systems for Determining Minimum Porosity for Presence of Clathrates in Sediment”, U.S. Patent Application No. ______, bearing the same title and filed the same day herewith, and U.S. Provisional Patent Application No. 61/727,560, filed on Nov. 16, 2012 and entitled “Methods and Systems for Determining Minimum Porosity for Presence of Clathrates in Sediment Using Empirical Relationships” (Docket No. T-9172), the disclosures of each of which are incorporated by reference in their entireties.

Furthermore, and referring to FIGS. 3-13, and in particular computing systems embodying the methods and systems of FIGS. 4-5 and 8-9, it is noted that various computing systems can be used to perform the processes disclosed herein. For example, embodiments of the disclosure may be practiced in various types of electrical circuits comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, aspects of the methods described herein can be practiced within a general purpose computer or in any other circuits or systems.

Embodiments of the present disclosure can be implemented as a computer process (method), a computing system, or as an article of manufacture, such as a computer program product or computer readable media. The computer program product may be a computer storage media readable by a computer system and encoding a computer program of instructions for executing a computer process. Accordingly, embodiments of the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media. Further, the disclosed methods' stages may be modified in any manner, including by reordering stages and/or inserting or deleting stages, without departing from the overall concept of the present disclosure.

The above specification, examples and data provide a complete description of the manufacture and use of the composition of the invention. Since many embodiments of the invention can be made without departing from the spirit and scope of the invention, the invention resides in the claims hereinafter appended.

1. A method of detecting a maximum pore size in a distribution of varying-sized spherical particles, the method comprising:
distributing a plurality of particles within a volume;
at each point unoccupied by a particle, inscribing a sphere and determining a size of the sphere; and
determining a maximum size of a sphere from among the spheres inscribed at each unoccupied point, thereby locating a maximum pore size location within the volume.

2. The method of claim 1, further comprising determining a grain size distribution for a natural sediment sample, wherein the grain size distribution is used to distribute the plurality of particles within the volume.

3. The method of claim 2, wherein distributing the plurality of particles within the volume includes distributing a plurality of modeled particles within the volume, wherein the volume comprises a model volume.

4. The method of claim 3, wherein distributing the plurality of particles within the model volume includes placing each particle in contact with at least one neighboring particle.

5. The method of claim 2, wherein determining a grain size distribution comprises performing at least one of a Stokes settling analysis and a laser diffraction analysis on the natural sediment sample.

6. The method of claim 2, wherein determining the grain size distribution includes:
capturing a digital image of the natural sediment sample;
rasterizing the digital image to discriminate between grains and pores in the natural sediment sample; and
computing porosity and median grain size based on the rasterized digital image.

7. The method of claim 6, wherein capturing a digital image comprises capturing an X-ray image, wherein the x-ray image comprises a tomographic image of the natural sediment sample representing a three-dimensional volume of the natural sediment sample.

8. The method of claim 1, wherein distributing a plurality of particles within a volume comprises forming the plurality of particles at each of a corresponding plurality of particle locations within a model volume by modeling growth of particles at each particle location.

9. The method of claim 8, wherein each of the plurality of particle locations comprises a randomly-selected particle location within the model volume.

10. The method of claim 9, further comprising, prior to forming particles, seeding the model volume with the plurality of randomly-selected particle locations.

11. The method of claim 8, wherein modeling growth of particles at each particle location includes modeling growth of each particle at a constant rate, and wherein, for each particle, growth of the particle halts upon contact with a neighboring particle.

12. The method of claim 8, wherein modeling growth of particles at each particle location includes modeling growth of each particle at a constant rate, and wherein, for each particle, growth of the particle halts upon reaching a predetermined distance from a neighboring particle.

13. The method of claim 1, wherein determining a maximum size of a sphere from among the spheres inscribed at each unoccupied point includes modeling a spherical clathrate particle at each point not occupied by one of the plurality of particles.

14. The method of claim 13, further comprising determining a theoretical clathrate saturation based at least in part on a determined saturation of the model volume with modeled spherical clathrate particles.

15. A computer-readable storage medium comprising computer-executable instructions which, when executed, cause a computing system to perform a method of detecting a maximum pore size in a distribution of varying-sized spherical particles, the method comprising:
distributing a plurality of particles within a volume;
at each point unoccupied by a particle, inscribing a sphere and determining a size of the sphere; and
determining a maximum size of a sphere from among the spheres inscribed at each unoccupied point, thereby locating a maximum pore size location within the volume.

16. The computer-readable storage medium of claim 15, wherein the method further includes determining a grain size distribution for a natural sediment sample, wherein the grain size distribution is used to distribute the plurality of particles within the volume, and wherein determining a grain size distribution comprises performing at least one of a Stokes settling analysis and a laser diffraction analysis on the natural sediment sample.

17. The computer-readable storage medium of claim 16, wherein determining the grain size distribution includes:
capturing a digital image of the natural sediment sample;
rasterizing the digital image to discriminate between grains and pores in the natural sediment sample; and
computing porosity and median grain size based on the rasterized digital image.

18. A computing system comprising:
a clathrate saturation probability application configured to execute on the computing system, the clathrate saturation probability application including a modeling component configured to distribute modeled particles within a model volume;
a pore size analysis component configured to inscribe a sphere and determine a size of the sphere at each point unoccupied by a modeled particle, and to determine a maximum size of a sphere from among the spheres inscribed at each unoccupied point, thereby locating a maximum pore size location within the volume.

19. The computing system of claim 18, wherein the clathrate saturation probability application includes a grain size analysis component configured to determine a grain size distribution for a natural sediment sample, wherein the modeling component is configured to distribute the modeled particles within the model volume according to the determined grain size distribution.

20. The computing system of claim 19, wherein the grain size analysis component includes an imaging component configured to capture tomographic images of the natural sediment sample.

21. The computing system of claim 15, wherein the modeling component is configured to distribute modeled particles within a model volume by placing each particle in contact with at least one neighboring particle.

22. The computing system of claim 18, wherein the modeling component distributes the modeled particles within the model volume by modeling growth of particles at each of a plurality of randomly-selected particle locations within the model volume.

23. The computing system of claim 18, wherein the grain size analysis component, the modeling component, and the pore size analysis component execute on the same microprocessor.
